(19) United States
(12) Patent Application Publication
(10) Pub. No.: US 2019/0359533 A1
(43) Pub. Date: Nov. 28, 2019

(54) COATED CONCRETE BODY

(71) Applicant: Wobben Properties GmbH, Aurich (DE)

(72) Inventors: Norbert HÖLSCHER, Aurich (DE); Edelfried VOIGT, Aurich (DE); Frank HOFFMANN, Engelskirchen (DE)

(21) Appl. No.: 15/752,220

(22) PCT Filed: Aug. 12, 2016
(86) PCT No.: PCT/EP2016/069232

§ 371 Date: Feb. 12, 2018

(30) Foreign Application Priority Data
Aug. 12, 2015 (DE) 102015215414.9

(51) Int. Cl. C04B 41/71; C04B 41/00; C04B 28/02; C04B 41/48; C04B 41/52; C04B 41/50

(52) U.S. Cl. CPC C04B 41/71; C04B 41/009; C04B 28/02; C04B 41/483; C04B 2111/27; C04B 41/522; C04B 41/4853; C04B 41/5079; C04B 41/4803; C04B 41/524

(57) ABSTRACT

A coated concrete body, more particularly an element for a tower, more particularly for a tower for a wind turbine, and also of a method for its production.

### BACKGROUND

### Technical Field

The present invention relates to a coated concrete body, more particularly an element for a tower, more particularly for a tower for a wind turbine, and also to a method for producing a coated concrete body of the invention.

### Description of the Related Art

The curing of concrete bodies is consistently accompanied by the surface formation of cavities, pores, and holes, which must be filled or closed in order to prevent the accumulation of rainwater and/or condensation with subsequent erosion as a result of heat/frost activity, to increase the mechanical robustness of the concrete surface, and/or for decorative reasons.

DE 10 2012 203 280 B4 discloses a method for the coating of concrete surfaces, more particularly of towers for wind turbines, comprising the steps of:
coating the concrete surface with a filling layer comprising a coating material containing a solvent-free two-component polyurea, the filling layer having a priming function,
pulling and/or chipping off the filling layer, the filling layer being removed such as to leave, over the entire concrete surface, a residue of the filling layer in differing layer thicknesses of at least 5 μm,
coating the concrete surface with a top layer, the top layer comprising a coating material composed of a low-solvent, two-component polyurea having a solvent fraction of below 20 wt %.

The polyureas present in the filling layer according to DE 10 2012 203 280 B4 are formed by reaction of polyaspartic esters (aspartates) with isocyanates. Using isocyanates and aspartates, though, presents problems for reasons of workplace and health protection. This is true especially of filling compounds, since in the course of their usually manual application to a surface using a spreading tool the worker is generally working in the direct vicinity of the surface to be coated and so is exposed to a substantially greater degree to these health-injurious substances than if a coating material were being applied, for example, by means of a roller. Consequently, in the coated application of coating materials, especially filling compounds, which comprise isocyanates and/or aspartates, costly and inconvenient personnel protection measures are required, such as the wearing of protective clothing and a protective mask.

Coatings for concrete bodies are required to meet a host of requirements in relation to workability, compatibility with the concrete (particularly the alkaline constituents thereof), adhesion to the concrete surface, and long-term resistance to effects of weathering, UV radiation, temperature fluctuation, humidity, and so on. In particular, in order to ensure rapid and hence economically efficient production of coated concrete bodies, the coating must be capable of being applied to the concrete which is not yet fully cured and which possibly even is still wet and warm, so that the coating adheres reliably to the concrete surface. Moreover, the coating, and also the filling compounds used for producing it, must as far as possible contain only small amounts of substances injurious to health or the environment, such as isocyanate and aspartates, for example, and are preferably to be free from isocyanate and aspartates. Furthermore, reliable filling or closing of the cavities, holes, and pores must be ensured.

### BRIEF SUMMARY

Provided is a coated concrete body comprising

(a) a concrete body having a concrete surface,

(b) a coating disposed on the concrete surface, the coating comprising
(i) a first coating layer selected from the group consisting of layers based on (meth)acrylate, epoxide, and aspartate polymers and copolymers and also layers based on saponification-resistant coating materials,
(ii) a second coating layer selected from the group consisting of layers based on (meth)acrylate, epoxide, aspartate, and urethane polymers and copolymers and also layers based on other saponification-resistant coating materials, and
(iii) a layer disposed between the first and second coating layers and formed of first mineral filling compound, and comprising a mineral binder,

wherein the coating possesses a tensile adhesive strength, determined according to DIN EN ISO 4624, of ≥1.0 N/mm² and/or the assembly composed of concrete body and coating possesses a fracture component in the concrete of ≥20%, determined according to DIN EN ISO 4624.

A further aspect of the invention lies in a method for producing a coated concrete body of the invention, comprising the steps of:

a) providing a concrete body,

b) providing coating material for the first coating layer,

c) providing coating material for the second coating layer,

d) providing the first mineral filling compound, the first mineral filling compound comprising a mineral binder

e) applying the coating material for the first coating layer directly or indirectly to the concrete body,

f) applying the first mineral filling compound over the surface of the first coating layer, and

g) applying the coating material for the second coating layer to the first mineral filling compound.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale.

FIG. 1 shows a schematic illustration of a wind turbine.

FIG. 2 shows a portion of a concrete body.

### DETAILED DESCRIPTION

Surprisingly it has emerged that with the coating method of the invention, coated concrete bodies can be produced economically and efficiently, and the coated concrete bodies have a firmly adhering, durable coating of long-term stability, despite the fact that is unusual in the prior art for mineral filling compounds to be applied to coating layers, particularly to coating layers composed of film-forming coating materials. Accordingly it is also not customary for a layer formed of mineral filling compound comprising a mineral binder to be disposed between two coating layers.

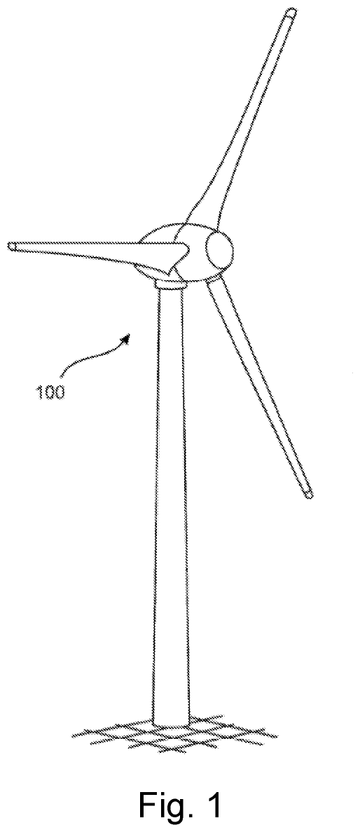

In accordance with methods customary in the prior art, the concrete body is produced from customary starting materials. In one preferred embodiment of the present invention, a concrete body is an element for a tower, more particularly for a tower for a wind turbine 100 of FIG. 1. The production of elements for a wind energy tower, in the form of concrete bodies, is part of the prior art.

When the coating is applied, the concrete of the concrete body typically has a residual moisture content of up to a maximum of 4 wt %, in certain cases also more than 4 wt %, and a temperature in the range from 1 to 55° C., preferably 15 to 50° C.

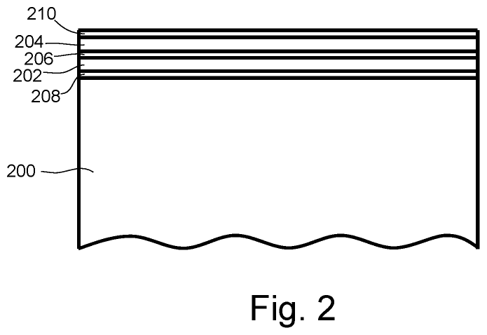

FIG. 2 shows a portion of a concrete body 200. A first coating layer 202 and also a second coating layer 204 are selected from the group consisting of layers based on (meth)acrylate, epoxide, urethane, and aspartate polymers and copolymers and also layers based on saponification-resistant coating materials.

The term “(meth)acrylate, epoxide, urethane, and aspartate polymers and copolymers” here encompasses
polymers which contain only one kind of repeating units from the group consisting of repeating (meth)acrylate, epoxide, urethane, and aspartate units
polymers which as well as one kind of repeating units from the group consisting of repeating (meth)acrylate, epoxide, urethane, and aspartate units comprise at least one kind of further repeating units (copolymers).

The further kind of repeating units in the copolymers is selected from the group consisting of repeating (meth)acrylate, epoxide, urethane, and aspartate units and repeating units formed from other molecules (comonomers).

In the case of the copolymers, preference is given to copolymers composed of repeating (meth)acrylate units and repeating units formed from other molecules (comonomers, e.g., styrene).

The term “(meth)acrylate” here encompasses both acrylate and methacrylate.

“Layers based on (meth)acrylate, epoxide, urethane, and aspartate polymers and copolymers” here means that the binder responsible for the adhesion and the cohesion of the layer to an extent of 50% or more, preferably 60% or more, more preferably 75% or more (based on the total mass of the binders present in the layer) is selected from the stated polymers and copolymers and mixtures thereof, with the corresponding polymer and/or copolymers being present in the coating material in an amount sufficient to form a firmly adhering, coherent coating layer.

“Saponification-resistant” here means that the alkaline constituents of the concrete body do not decompose the coating layer formed from the coating material.

The function of the first coating layer 202 is that of a primer. It assures adhesion between the concrete surface and the layer which is formed from a first mineral filling compound and which comprises a mineral binder. Because of the closeness of the first coating layer to the concrete surface, the binders for use here in particular must fulfill the requirement of saponification-resistance.

Film-forming coating materials are employed preferably as coating material for the first coating layer.

The second coating layer 204 serves in particular for sealing the surface and, in preferred embodiments (see below), for improving the adhesion of further layers, such as a third coating layer, which functions for example as a topcoat. In certain embodiments which do not include a third coating layer (in this regard, see later on below), the second coating layer itself also functions as a topcoat (outer layer). If the second coating layer functions as the (outer) topcoat, it is preferably selected from the group consisting of layers based on (meth)acrylate, urethane, and aspartate polymers and copolymers and also layers based on other weathering-resistant coating materials. The test of weathering resistance takes place according to DIN EN ISO 4892-3.

The coating materials that are used for the application of the first and second coating layers 202, 204 (step e) and step g), respectively) are aqueous, solvent-containing or solvent-free, one- or multi-component coating materials. Particularly preferred are aqueous coating materials and also coating materials which contain no organic solvents (solvent-free coating materials). Among the solvent-containing coating materials, low-solvent coating materials are preferred.

Solvents are considered in connection with the present invention to be solvents in the sense of TRGS (Technical Rules on Hazardous Substances) 610 of the German Federal Institute of Workplace Protection and Occupational Medicine (BAuA), i.e., volatile organic solvents having a boiling point of 200° C. which are liquid under standard conditions (20° C. and 101.3 kPa) and which are used to dissolve or dilute other substances without causing their chemical alteration.

Solvent-free here means that neither do the basic substances of the coating material contain solvents, and nor are solvents added during either the production or the application of the coating material. A minimal solvent fraction (<0.5 wt %) may result from impurities. Low-solvent here means that the coating material has a solvent fraction of below 20 wt %, based on the total mass of the coating material.

Preference is given to using coating materials from the group consisting of solvent-containing, one-component (meth)acrylate coating materials, aqueous or 100% epoxy resins, urethanes or precursors thereof, and aqueous one-component (meth)acrylate dispersions.

Application of the first coating layer 202 and of the second coating layer 204 takes place by means of methods and devices which are customary in the prior art, as for example by roller application using paint rollers, or spray applications, such as high-pressure, airless and air-mix spraying methods.

In one embodiment of the concrete body of the invention it is possible for the first coating layer 202 to be disposed directly on the concrete body 200, i.e., on the concrete surface of the concrete body. In the corresponding embodiment of the method, the first coating layer is applied in step e) directly to the concrete body, i.e., to the concrete surface of the concrete body.

In an alternative, preferred embodiment of the concrete body of the invention, the first coating layer 202 is disposed indirectly on the concrete body 200, i.e., between the concrete surface and the first coating layer 200 there are one or more further layers disposed. In the corresponding embodiment of the method, the first coating layer is applied in step e) indirectly to the concrete body, i.e., to the surface of the one or more further layers disposed on the concrete surface.

In the coating disposed on the concrete surface of the concrete body, there is a layer of first mineral filling compound 206 disposed between the first and second coating layers 202, 204, said compound comprising a mineral binder. In one preferred embodiment the layer of first mineral filling compound 206 is disposed directly between the first and second coating layers 202, 204; in other words, a first surface of the layer of first mineral filling compound 206 borders a surface of the first coating layer 202, and a second surface, opposite the first surface, of the layer of first mineral filling compound 206 borders a surface of the second coating layer 204. In an alternative preferred embodiment, the layer of first mineral filling compound 206 which comprises a mineral binder is disposed indirectly between the first and second coating layers 202, 204; in other words, at least one surface of the layer of first mineral filling compound 206 borders a surface of a layer which is different from the first coating layer 202 and from the second coating layer 204.

A mineral filling compound is a filling compound which
comprises mineral solids in particle form,
has a fraction of mineral substances of 50 wt % or more, preferably 60 wt % or more, more preferably 70 wt % or more, very preferably 80 wt % or more, and especially preferably 90 wt % or more, based in each case on the dry weight of the mineral filling compound,
sets hydraulically,
contains 1 wt % or less of isocyanates, preferably 0.5 wt % or less of isocyanates, more preferably 0.1 wt % or less of isocyanates, based in each case on the dry weight of the mineral filling compound, and especially preferably contains no isocyanates, and
contains 5 wt % or less of aspartates, preferably 2 wt % or less of aspartates, more preferably 1 wt % or less of aspartates, very preferably 0.5 wt % or less of aspartates, based in each case on the dry weight of the mineral filling compound, and especially preferably contains no aspartates.

Particularly preferred mineral filling compounds and layers formed of them are those which contain no isocyanates and no aspartates and no reaction products of isocyanates and aspartates.

The mineral filling compound 206 is preferably a cementitious mineral filling compound, i.e., one which comprises cement, more particularly Portland cement.

The mineral filling compound 206 is preferably a polymer-enhanced mineral filling compound. Polymer-enhanced mineral filling compounds typically contain up to 20 wt %, preferably up to 15 wt %, more preferably up to 10 wt % of organic binders (polymer), in addition to the hydraulically setting mineral binders.

The first mineral filling compound 206 is applied by means of methods and devices that are customary in the art, examples being spreaders, finishing trowels, masonry trowels, surfacing spatulas, Japanese spatulas, palette knives.

Applying the first mineral filling compound 206 over the surface means in accordance with the invention at the first mineral filling compound is not applied exclusively to the pores and cavities that are to be filled, but is instead also applied to the area surrounding these pores and cavities. The area to which the first mineral filling compound 206 is applied, to form a layer completely covering this area, preferably has a size of at least 10 cm², preferably 1 m² or more, and more preferably the first mineral filling compound is applied over the entire area of a concrete surface of the concrete body.

The pores, holes, and cavities to be filled typically occupy 1% to 10% of the concrete surface. Since they are typically distributed over the whole of the surface to be coated, application of the first mineral filling compound over the whole area, preferably with subsequent removal (preferentially by pulling or chipping off), is more economical than targeted filling of the individual pores and holes. In certain cases, pores, cavities, and holes are concentrated over smaller subregions of the concrete surface. If only these regions are considered, the pores may occupy around 40-50% of these subregions.

The tensile adhesive strength is determined according to DIN EN ISO 4624. The tensile adhesive strength is preferably 1.5 N/mm² or more, more preferably 2 N/mm² or more, measured in each case after 24 hours of drying at 20° C.

The fracture component in the concrete is determined according to DIN EN ISO 4624. The fracture component in the concrete is preferably more than 30%, more preferably more than 50%, and very preferably 100%, measured in each case after 24 hours of drying at 20° C.

In one preferred embodiment, the coated concrete body, between the concrete surface of the concrete body and the first coating layer, comprises a layer which is formed of second mineral filing compound 208, with this layer preferably being disposed locally in the cavities, holes, and pores of the concrete surface 200. In the corresponding embodiment of the method, before step e), a second mineral filling compound 208 is provided and is applied preferably locally in the region of the cavities, pores, and holes. Outside the pores, holes and cavities, the as yet uncured second mineral filling compound is preferably removed again completely. Removal of the second filling compound is accomplished preferably by pulling and/or chipping off. With regard to the definition of the term “mineral filling compound”, the valid definition is that indicated above for the second mineral filling compound. The first and second mineral filling compounds may have identical or different compositions. The second mineral filling compound preferably has a coarser particle size than the first mineral filling compound.

With regard to its particle size distribution, the second mineral filling compound 208 is selected with particular preference such that it is capable of closing up, in particular, pores and cavities having a size of 10 mm, and in terms of its particle size distribution the first mineral filling compound is selected such that it is capable of closing up, preferably in a flush manner, the pores and cavities, in particular having a size of 10 to 20 mm and/or <10 mm, that are not completely closed up or filled by the second mineral filling compound.

A further criterion to be borne in mind when selecting the first and second mineral filling compounds is that they do not burn up on the possibly still warm or hot concrete surface.

Preference is given to coated concrete bodies and methods in which the first and second coating layers and also the coating materials used for producing them feature an organic binder, based for example on epoxide, (meth)acrylate, urethane, or aspartate polymers or copolymers.

The first mineral filling compound and the layer formed from it feature a mineral (inorganic) binder, based for example on cement.

Where a second mineral filling layer is present, it is in certain cases preferred for the second mineral filling compound as well, and the layer formed from it, to feature a mineral (inorganic) binder, based for example on cement.

The preferred embodiment of the concrete body, with a layer formed of second mineral filling compound, as defined above, and the corresponding embodiment of the method, are notable for the fact that particularly reliable and complete filling or closing of pores and cavities is achieved. As a result of the additional application of the second mineral filling compound, there is initial filling in particular of coarse pores and cavities, whereas the first mineral filling compound has the effect, among others, of compensating the volume contraction that occurs during drying of the second mineral filling compound.

Preferably, in the method, before step e)—or, if a second mineral filling compound is provided and applied to the concrete body before step e), then before application of the second mineral filling compound—on the concrete surface, dust or other loose constituents are reduced and/or pores and cavities are opened, in particular by means of a measure selected from the group consisting of attacking with compressed air, mechanically abrading, sweeping with a wire broom, sanding down, or wiping. The opening of pores and cavities is necessary particularly when in the freshly produced concrete body they are covered over by a film of cement.

Preference is given to a method wherein the coating material and/or the mineral filling compound are/is applied to the concrete surface and/or to the previously applied layer, respectively, before the concrete surface and/or the previously applied layer, respectively, are/is fully cured.

Completely cured here means that no further curing is possible any longer. Since a long time is required for complete curing, especially of the concrete surface, it is particularly preferred for the layer to be applied, in steps e), f) and/or g), to be applied to the concrete surface or, respectively, to the layer applied beforehand, before the concrete surface or, respectively, the layer applied beforehand is completely cured.

In one preferred embodiment, the coating of the coated concrete body comprises a third coating layer 210. If the third coating layer functions as the (outer) topcoat, it is preferably selected from the group consisting of layers based on (meth)acrylate, urethane, and aspartate polymers and copolymers and also layers based on other weathering-resistant coating materials. The test of weathering resistance is carried out according to DIN EN ISO 4892-3.

With particular preference this third coating layer is disposed directly on that surface of the second coating layer that is facing away from the layer formed of the first mineral filling compound. In the corresponding embodiment of the method, according to step g), coating material for a third coating layer is provided and applied.

The third coating layer is applied by means of methods and devices which are customary in the prior art, as for example by roller application using paint rollers, or spray applications, such as high-pressure, airless, and air-mix spraying methods.

In one particularly preferred variant of the method, after step f), the first mineral filling compound is removed in such a way as to produce
an average coating thickness of the first mineral filling compound of 0.005 mm to 2 mm, preferably 0.08 mm to 1.5 mm, more preferably 0.01 mm to 1 mm

and/or
an average application rate of dry mineral filling compound of 10 g/m² to 500 g/m², preferably 40 g/m² to 400 g/m², more preferably 40 g/m² to 150 g/m².

As small as possible a thickness for the layer formed of the first mineral filling compound ensures a high level of tensile adhesive strength on the part of the coating.

The removal of the first mineral filling compound and, where appropriate, of the second mineral filling compound takes place preferably by pulling off and/or chipping off, by means of methods and devices which are customary in the art, examples being finishing trowels, surfacing spatulas, and Japanese spatulas.

The coated concrete body, particularly in the preferred embodiments described above, is notable for the presence of one, preferably two or more, or all of the following qualities:
effective adhesion of the coating on the concrete surface
high UV and weather resistance of the coating
high long-term stability of the coating
high integrity of gloss and shade
mechanical robustness of the coating
reliable protection of the concrete body from atmospheric effects
capacity for bridging of cracks.

Particularly preferred coated concrete bodies are those having two or more of the above-stated preferred features (unless they are alternative features which cannot be present simultaneously in one and the same coated concrete body).

Particularly preferred methods for producing coated concrete bodies are those which have two or more of the above-stated preferred features (unless they are alternative features which cannot be actualized simultaneously in one and the same method variant of the invention).

With particular preference the coated concrete body is an element for a tower for a wind turbine, the element comprising:

(a) a concrete body having a concrete surface

(b) a coating disposed on the concrete surface, the coating comprising

(i) a first coating layer selected from the group consisting of layers based on (meth)acrylate, epoxide, and aspartate polymers and copolymers,

(ii) a second coating layer selected from the group consisting of layers based on (meth)acrylate, epoxide, aspartate, and urethane polymers and copolymers, and

(iii) a layer disposed between the first and second coating layers and formed of first mineral filling compound, and comprising a mineral binder, this layer being free from epoxides, isocyanates, aspartates, and reaction products thereof, wherein the coating possesses a tensile adhesive strength, determined according to DIN EN ISO 4624, of 1.5 N/mm² and/or the assembly composed of concrete body and coating possesses a fracture component in the concrete of 30%, determined according to DIN EN ISO 4624.

In another preferred variant, an element for a tower for a wind turbine comprises

(b) a concrete body having a concrete surface

(b) a coating disposed on the concrete surface, the coating comprising
(i) a first coating layer selected from the group consisting of layers based on (meth)acrylate, epoxide, and aspartate polymers and copolymers,
(ii) a second coating layer selected from the group consisting of layers based on (meth)acrylate, epoxide, aspartate, and urethane polymers and copolymers, and
(iii) a layer disposed between the first and second coating layers and formed of first mineral filling compound, and comprising a mineral binder, this layer being free from epoxides, isocyanates, aspartates, and reaction products thereof,

further comprising, between the concrete surface of the concrete body and the first coating layer, a layer formed of second mineral filling compound, this layer being free from epoxides, isocyanates, aspartates, and reaction products thereof,

wherein the coating possesses a tensile adhesive strength, determined according to DIN EN ISO 4624, of ≥1.5 N/mm² and/or the assembly composed of concrete body and coating possesses a fracture component in the concrete of ≥30%, determined according to DIN EN ISO 4624.

With particular preference the method of the invention is a method for producing an element for a tower for a wind turbine,

comprising the steps of:

a) providing a concrete body for an element for a tower for a wind turbine,

b) providing coating material for the first coating layer,

c) providing coating material for the second coating layer,

d) providing a first mineral filling compound which comprises a mineral binder and is free from epoxides, isocyanates, aspartates, and reaction products thereof

e) applying the coating material for the first coating layer directly or indirectly to the concrete body,

f) applying the first mineral filling compound over the surface of the first coating layer, and

g) applying the coating material for the second coating layer to the first mineral filling compound.

In certain cases, a variant of this method for producing an element for a tower for a wind turbine is preferred

wherein after step f) the first mineral filling compound is removed so as to produce an average coating thickness of the first mineral filling compound of 0.005 mm to 2 mm and/or an average application rate of dry first mineral filling compound of 40 g/m² to 150 g/m²,

wherein before step e) a second mineral filling compound is provided and is applied locally in the region of the cavities, pores, and holes on the concrete surface, this compound being free from isocyanates, aspartates, and reaction products thereof.

Through the use of mineral filling compounds which comprise a mineral binder and are free from epoxides, isocyanates, aspartates, and reaction products thereof, it is possible to avoid costly and inconvenient personnel protection measures such as the wearing of protective clothing and a protective mask.

The invention is elucidated below using examples.

### Concrete Bodies

The concrete bodies used for examples 1 and 2 are elements for a tower for a wind turbine, which have been produced conventionally.

### Preparation of the Concrete Surface (Optional)

The surface is cleaned where necessary to remove dust and impurities. Insofar as the concrete surface of the concrete body has cavities and pores that are closed near to the surface, they are opened up using a wire broom. If required, compressed air is employed for assistance.

Layer formed from (second) mineral filling compound in the region of the cavities, pores, and holes (optional)

Using a masonry trowel, a mineral filling compound (product name Ardex A 46, manufacturer: Ardex GmbH, Witten, Germany) is applied at an application rate of 70 g/m² to 150 g/m², to the approximately 8-hour-old concrete surface of the concrete body, this surface preferably having a residual moisture content of 4 wt % or less and a temperature in the range from 15 to 45° C., the application being made so as to seal cavities, holes, and pores.

Outside of the pores and cavities, the as yet uncured mineral filling compound is chipped off and/or pulled off by means of a Japanese spatula.

The drying time of the layer formed from the (second) mineral filling compound is 20 to 60 minutes.

### First Coating Layer

For the production of a concrete body of the invention as per example 1, the coating material applied for the first coating layer is a two-component, pigmented, water-dispersed epoxy resin formulation (product name: MC DUR 1177 WPT, manufacturer MC-Bauchemie Willer GmbH & Co. KG, Bottrop, Germany) in an amount of 50 g/m² to 150 g/m², preferably of 80 to 100 mg/m², using a paint roller. The drying time of the first coating layer is 60 to 120 minutes.

For the production of a concrete body of the invention as per example 2, the coating material applied for the first coating layer is an acrylic resin coating material (product name Sikagard 680 S Betoncolor, manufacturer Sika Deutschland GmbH, Stuttgart, Germany) in a wet film thickness of 80 to 120 μm, preferably 100 μm, and/or with an application rate of 100 g/m² to 250 g/m², preferably 150 to 200 g/m². The minimum drying time of the first coating layer is 15 to 30 minutes.

Layer Formed from First Mineral Filling Compound

After the drying time of the first coating layer (as indicated above), the surface thereof receives a mineral filling compound (product name Ardex F3, manufacturer: Ardex GmbH, Witten, Germany), applied over the surface by means of a finishing trowel; during this step of work, pores and cavities are sealed by means of corresponding pressure on the finishing trowel. Immediately after application has been made, the mineral filling compound is chipped off and/or pulled off again with a surfacing spatula in the direction opposite to the direction of application, to give an average coating thickness of the first mineral filling compound of 0.005 mm to 2 mm and/or an average application rate of dry filling compound of 10 g/m² to 500 g/m², preferably 40 g/m² to 80 g/m².

### Second Coating Layer

For the production of a concrete body of the invention as per example 1, the coating material applied for the second coating layer is a two-component, pigmented, water-dispersed epoxy resin formulation (product name: MC DUR 1177 WPT, manufacturer MC-Bauchemie Willer GmbH & Co. KG, Bottrop, Germany) in an amount of 10 mg/m² to 100 mg/m², preferably of 20 mg/m² to 50 g/m². The drying time of the second coating layer is 30 to 60 minutes.

For the production of a concrete body of the invention as per example 2, the coating material applied for the second coating layer is an acrylic resin coating material (product name Sikagard 680 S Betoncolor, manufacturer Sika Deutschland GmbH, Stuttgart, Germany) in a wet film thickness of 100 to 250 μm, preferably 150 μm to 200 μm, using a lambs wool roller.

### Third Coating Layer (Optional)

For the production of a concrete body of the invention as per example 1, the coating material applied for the third coating layer is a two-component polyaspartate-based topcoat (product name: solvatic 2K PUR topcoat HS ZD58 concrete, manufacturer: Dresdner Lackfabrik novatic GmbH & Co. KG., Dresden, Germany) in a wet film thickness of 100 μm to 300 μm, preferably 150 μm to 180 μm, at an application rate of 200 g/m² to 400 g/m², preferably 200 to 330 g/m², using a paint roller.

For the production of a concrete body of the invention as per example 2, the coating material applied for the third coating layer is again an acrylic resin coating material (product name Sikagard 680 S Betoncolor, manufacturer Sika Deutschland GmbH, Stuttgart, Germany), application taking place by means of a lambs wool roller such that the total application rate of Sikagard 680 S Betoncolor from the second and third layers is 350 g/m² to 500 g/m², preferably 400 g/m² to 450 g/m².

### Tensile Adhesive Strength According to DIN EN ISO 4624

The tensile adhesive strength according to DIN EN ISO 4624, measured after 24 hours of drying of the coated concrete body from example 1 at 20° C., is 3 to 4 N/mm².

The tensile adhesive strength according to DIN EN ISO 4624, measured after 24 hours of drying of the coated concrete body from example 2 at 20° C., is 3-4 N/mm².

### Fracture Component in the Concrete According to DIN EN ISO 4624

The fracture component in the concrete according to DIN EN ISO 4624, measured after 24 hours of drying of the coated concrete body from example 1 at 20° C., is 60 to 100%.

The fracture component in the concrete according to DIN EN ISO 4624, measured after 24 hours of drying of the coated concrete body from example 2 at 20° C., is 60 to 100%.

1. A coated concrete body comprising:
(a) a concrete body having a concrete surface;
(b) a coating disposed on the concrete surface, the coating comprising:
(i) a first coating layer selected from the group consisting of layers based on (meth)acrylate, epoxide, and aspartate polymers and copolymers and also layers based on saponification-resistant coating materials,
(ii) a second coating layer selected from the group consisting of layers based on (meth)acrylate, epoxide, aspartate, and urethane polymers and copolymers and also layers based on other saponification-resistant coating materials, and
(iii) a layer disposed between the first and second coating layers and formed of a first mineral filling compound, and comprising a mineral binder,
wherein the coating possesses a tensile adhesive strength, according to DIN EN ISO 4624, of ≥1.0 N/mm² and/or the assembly composed of concrete body and coating possesses a fracture component in the concrete of ≥20%, according to DIN EN ISO 4624.

2. The coated concrete body as claimed in claim 1, comprising, between the concrete surface of the concrete body and the first coating layer, a layer formed of a second mineral filling compound.

3. The coated concrete body as claimed in claim 1, wherein the coating comprises a third coating layer selected from the group consisting of layers based on (meth)acrylate, urethane, and aspartate polymers and copolymers and layers that are weathering-resistant coating materials.

4. The coated concrete body as claimed in claim 1, wherein the concrete body is an element for a tower.

5. A method comprising:
coating a concrete body, wherein coating comprising:
applying a first coating material over a surface of a concrete body to form a first coating layer directly or indirectly on the surface of the concrete body, the first coating layer selected from the group consisting of layers based on (meth)acrylate, epoxide, and aspartate polymers and copolymers and also layers based on saponification-resistant coating materials,
applying a first mineral filling compound over a surface of the first coating layer, and
applying a second coating material to form a second coating layer to the first mineral filling compound, the second coating layer selected from the group consisting of layers based on (meth)acrylate, epoxide, aspartate, and urethane polymers and copolymers and also layers based on other saponification-resistant coating materials,
wherein the coating possesses a tensile adhesive strength, according to DIN EN ISO 4624, of ≥1.0 N/mm² and/or the assembly composed of concrete body and coating possesses a fracture component in the concrete of ≥20%, according to DIN EN ISO 4624.

6. The method as claimed in claim 5, wherein before applying the coating material to form the first coating layer, applying a second mineral filling compound to the surface of the concrete body.

7. The method as claimed in claim 5, wherein before applying the coating material to form the first coating layer, removing dust or other loose constituents from the surface of the concrete body.

8. The method as claimed in claim 5, wherein at least one of: applying the coating material to form the first coating layer, applying the coating layer to form the second coating layer, or applying the first mineral filling compound, occurs before a prior layer or the surface of the concrete body has fully cured.

9. The method as claimed in claim 5, further comprising applying a coating material to form a third coating layer over the second coating layer.

10. The method as claimed in claim 5 further comprising removing portions of the first mineral filling compound to produce an average coating thickness of the first mineral filling compound of 0.005 mm to 2 mm.

11. The method as claimed in claim 5 further comprising removing portions of the first mineral filling compound to produce an average application rate of dry mineral filling compound of 10 g/m² to 500 g/m².

12. The method as claimed in claim 6, wherein before applying the second mineral filling compound, on the concrete surface, removing dust or other loose constituents on the concrete body.

13. The method as claimed in claim 7, wherein removing dust or other loose constituents comprises attacking the concrete body with compressed air, using mechanical abrasion, sweeping the concrete body with a wire broom, sanding down the concrete body, or wiping the concrete body.
